(19) United States
(12) Patent Application Publication
(10) Pub. No.: US 2004/0251860 A1
(43) Pub. Date: Dec. 16, 2004

(54) Advanced sensorless drive technique for brushless DC motors

(76) Inventors: Mehrdad Ehsani, College Station, TX (US); Taehyung Kim, College Station, TX (US)

Correspondence Address: PAUL S MADAN, MADAN, MOSSMAN & SRIRAM, PC, 2603 AUGUSTA, SUITE 700, HOUSTON, TX, 77057-1130, US

(21) Appl. No.: 10/754,262

(22) Filed: Jan. 9, 2004

Related U.S. Application Data
(60) Provisional application No. 60/438,949, filed on Jan. 9, 2003.

(51) Int. Cl. H02P 5/06

(52) U.S. Cl. 318/254

(57) ABSTRACT

Systems and methods for determining the position of the rotor of brushless DC motor drives over a wide speed range from near zero to high speed without additional hardware. This sensorless method and system provides continuous rotor position information with good accuracy and resolution even at very low speed operation, making them suitable for high performance applications. Motor current is detected from two of three motor phases and is compared with reference values. A speed-independent function is calculated to generate continuous rotor position information that covers almost all speed ranges from near zero to high speed. Suitable control of current and speed may then be provided to the motor.

This application claims the priority of U.S. provisional patent application No. 60/438,949 filed Jan. 9, 2003.

### BACKGROUND OF THE INVENTION

1. Field of the Invention

The invention relates to systems and methods for determining the rotor position of a brushless DC motor. In other aspects, the invention relates to systems and methods for control of a brushless DC motor.

2. Description of the Related Art

The brushless DC motor (“BLDCM”) drive is one of the fastest growing areas of motion control in the world today. To drive a BLDCM, rotor position information is required to provide the proper stator phase current commutation sequence. Conventionally, this has been accomplished by using a variety of rotor-position sensing devices, including optical encoders, resolvers, and Hall- effect sensors. These devices typically provide the feedback signals required for proper rotor position information to generate the correct switching patterns. Well-known disadvantages to these rotor-position sensing devices include 1) the cost of the sensors, 2) additional required space in or around the electric motor for the sensors to reside, and 3) the addition of fragile small gauge signal wires. Additionally, these rotor-position sensing devices are often unreliable and vulnerable to high temperatures, vibration, and so forth.

When the problems with conventional position sensors are considered, alternative methods to obtain rotor position information become highly desirable. In the last two decades, in order to eliminate sensor-caused problems, many researchers have presented various position sensorless operation methods for BLDCM drives. These sensorless methods may be grouped into four categories as follows:

1. Back-electromotive force (“EMF”) information-based sensorless techniques.

A) Back-EMF integration methods;

B) Zero-crossing point in back-EMF sensing methods;

C) The third-harmonic back-EMF sensing method.

2. Measured current information-based sensorless techniques.

A) Freewheeling diode current conduction sensing method;

B) Current waveform misalignment-detection method;

3. Using alterations in machine design.

4. Using fundamental machine equations, and algebraic manipulations.

Most popular and practical methods for sensorless drive belong to category one. However, the methods in the first category directly depend on the back-EMF information. Neither those methods nor the methods of category two can work properly when the magnitude of back-EMF is small. This occurs at low speeds. Except for special alterations that have been made in some machine designs, the back-EMF is zero at standstill and proportional to speed. Thus, methods in category one and two cannot be realized at very low speed operation. This speed limitation has been a major drawback for sensorless operation of the BLDCM drives. Another disadvantage of the methods that depend on back-EMF information to estimate position is the additional cost of hardware for sensing terminal voltages. To estimate position, these arrangements need six-additional hardware sensing circuits and A/D converter channels to sense three-phase voltages and currents. Since the shape and magnitude of a phase back-EMF or line-to-line back-EMF is changing with motor speed, sensorless drive methods using back-EMF or line-to-line back-EMF information usually give only discrete position information at commutation points or zero-crossing points. Therefore, continuous position information that may be needed for advanced motor controls and system level purposes is not provided.

A solution to the problems of the prior art would be desirable.

### SUMMARY OF THE INVENTION

The present invention provides systems and methods for determining the position of the rotor of brushless DC motor drives. The novel sensorless drive technique covers a wide speed range from near zero to high speed without additional hardware. This sensorless method and system also provides continuous rotor position information with good accuracy and resolution even at very low speed operation, making them suitable for high performance applications. Furthermore, the systems and methods of the present invention are simple enough to implement in real-time using an economical, fixed-point microprocessor. Motor current is detected from two of three motor phases and is compared with reference values. A speed-independent function is calculated to generate continuous rotor position information that covers almost all speed ranges from near zero to high speed. Since the speed term is technically eliminated from the calculation, identical shape of the position information can be presented over the entire speed range. Suitable control of current and speed may then be provided to the motor. The systems and methods of the present invention remove the need for external hardware to sense back-EMF information while presenting a high accuracy estimation of rotor position even at very low speed. These features make it suitable for high performance applications.

### BRIEF DESCRIPTION OF THE DRAWINGS

The advantages and further aspects of the invention will be readily appreciated by those of ordinary skill in the art as the same becomes better understood by reference to the following detailed description when considered in conjunction with the accompanying drawings in which like reference characters designate like or similar elements throughout the several figures of the drawing and wherein:

FIG. 1 is a schematic diagram of an exemplary brushless DC motor drive system having a sensing system in accordance with the present invention.

FIG. 2 is a timing diagram for a system depicting three-phase back-EMFs and currents.

FIG. 3 is a detailed diagram of the voltage source inverter used in the drive system shown in FIG. 1.

FIG. 4a is a diagram of waveforms of a phase H(θ) function, line-to-line H(θ) functions, and a square wave current.

FIG. 4b is a diagram of G(θ) waveform.

FIG. 5 depicts the exemplary G(θ) function, commutation signal, phase current and speed for a motor drive operated in accordance with the present invention.

FIG. 6 is a correlation of G(θ) function with two phase currents.

FIG. 7 is a flow chart depicting steps in an exemplary method in accordance with the present invention.

### DETAILED DESCRIPTION OF THE PREFERRED EMBODIMENTS

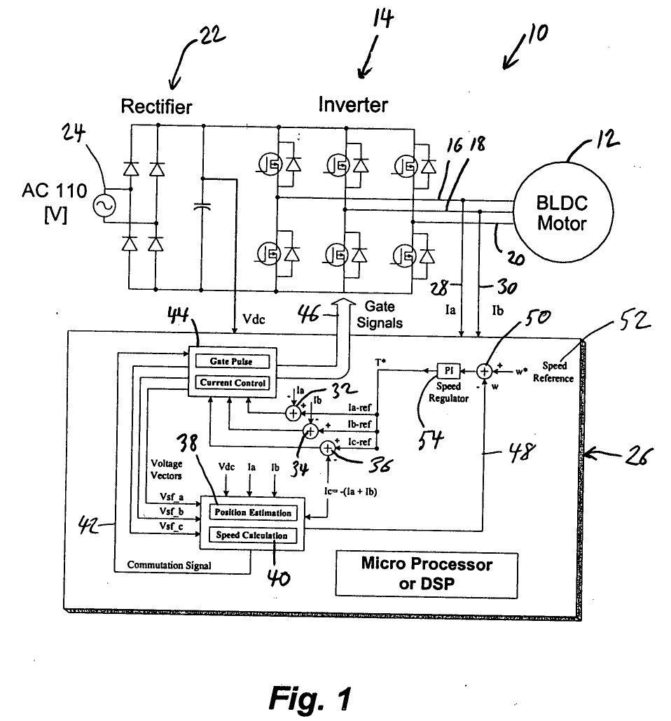

FIG. 1 schematically depicts a brushless DC motor drive system 10 in accordance with the present invention. The system 10 includes a brushless DC motor 12 and voltage source inverter 14 of a type known in the art. The motor 12 includes an outer stator (not shown) and a rotatable rotor (not shown) that rotates within the stator. The exemplary motor 12 has three electromagnetic phases, and each of the phases is provided with an electric lead 16, 18, 20, respectively, which extends from the motor 12 to the voltage source inverter 14. A rectifier 22, for conversion of AC power to DC power, and 110 V AC power supply 24 are operably associated with the voltage source inverter 14. Because the structure and operation of rectifiers and voltage source inverters are well understood by those of skill in the art, they are not described in any detail herein.

A processor 26 is also included in the drive system 10. The processor 26 may be a microprocessor or digital signal processor (DSP) of types that are known in the art. Current taps 28, 30 extend from motor leads 16, 18, respectively, to the processor 26 and are used to detect the current, Ia and lb, respectively, on each motor lead 16, 18. It is noted that only two of the three currents of the motor phases are sensed for current controlled sensorless operation. In this case, leads 16 and 18 have current sensed, while lead 20 does not. Under balanced conditions, the three-phase currents always meet the following condition, such as:

I₃=−(I₁+I₂) (1)

This equation implies that one of the three-phase currents (Ic) can be composed by the summation of the other phase currents. Reference voltage (Vdc) from the rectified voltage source 24 is also provided to the processor 26.

The processor 26 includes suitable on-board memory and processing means for carrying out the processes, functions and steps that will be described. As is known in the art, such functions, processes and steps may be accomplished using suitable programming of a programmable processor 26 as well as by hardwired means or preprogrammed media. In a currently preferred embodiment, and depicted schematically in FIG. 1, the processor 26 includes on-board comparator means 32, 34, respectively, for comparing each of the sensed currents Ia and Ib to predetermined reference currents Ia-ref and Ib-ref. A third comparator means 36 is also provided for comparing a calculated third current Ic to a predetermined reference current Ic-ref for the third motor phase.

A rotor position estimation function 38 and speed calculation function 40 are depicted schematically on processor 26. These functions 38,40 receive, as inputs, the detected motor currents Ia and Ib as well as the calculated current Ic and the reference voltage Vdc. The position estimation function 38 provides a commutation signal 42 as an output to a current control and gate pulse 44. The current control and gate pulse 44 is known circuitry that provides gate pulse signals 46 to the inverter 14 in order to selectively control the current, and consequently the torque, of the motor 12. The speed calculation function 40 provides a calculated speed signal (ω) 48 to a comparator 50. The comparator 50 compares the speed signal 48 to a predetermined reference speed 52 and generates a signal that is indicative of the differential. Any differential between the calculated speed signal 48 and the reference speed 52 is provided to a speed regulator 54, which is a device that is known in the art. The speed regulator 54 is capable of adjusting the speed of the motor 12 to compensate or correct for the differential between calculated speed and reference speed.

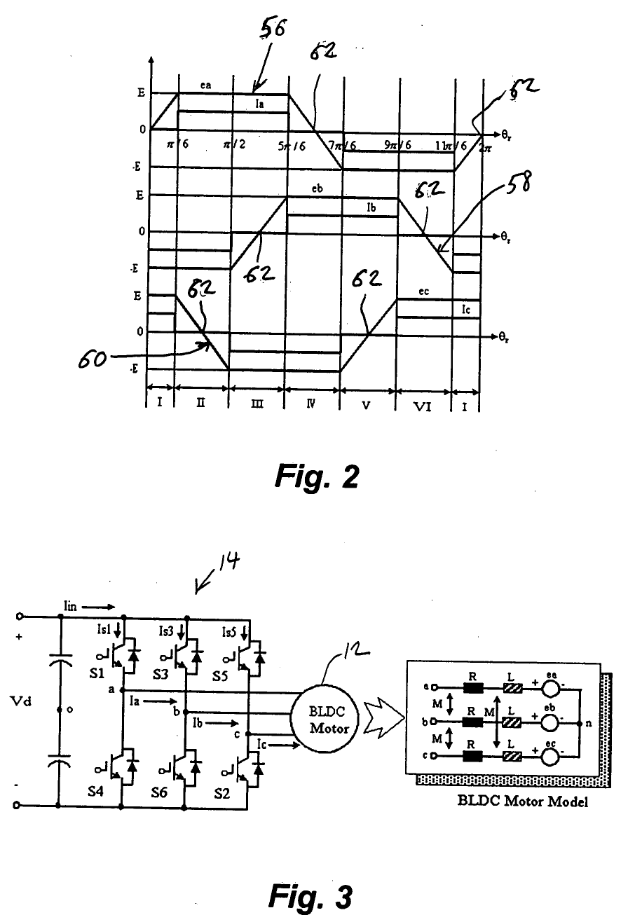

FIG. 2 illustrates a profile for an exemplary motor system having three-phase back EMFs, depicted as lines 56, 58, and 60 and show how the back EMFs and currents (Ia, Ib, Ic) change as the motor 12 moves through cycles (rotor positions I, II, III, IV, V, VI corresponding to 60° electrical angles). In prior art operation of the BLDC motor 12, each phase back-EMF 56, 58, 60 was aligned with the phase current (Ia, Ib, or Ic). The switching instance of the inverter 14 was obtained by knowing the zero-crossing points 62 of the back-EMF and a speed-dependent period of time delay. To monitor or sense the sloped phase back-EMF of the silent phase, the prior art techniques usually sense terminal voltages. Since back-EMF is zero at stand-still and proportional to speed, it is not possible to use the terminal voltage sensing method to obtain a switching pattern at low speeds. Also, back-EMF or line-to-line back-EMF based sensorless methods usually provide only zero-crossing points 56 as position information in variable speed drives.

To overcome this drawback of the previous methods, the methods and systems of the present invention feature a sensorless method for the BLDC drive 10, which can successfully apply from near zero to high speeds without sensing terminal voltages to know the back-EMF information. This eliminates redundant hardware circuits for estimation of rotor position and provides continuous position information with good accuracy using the processor 26.

FIG. 3 shows an equivalent circuit of the voltage source inverter 14 and BLDC motor 12. Here, each phase voltage equation can be expressed as:

$$\begin{matrix}\begin{matrix}V = {Ri}_{s} + {L}_{s} \frac{ⅆ {i}_{s}}{ⅆ t} + \frac{ⅆ {λ}_{r}}{ⅆ t} & & & ( {L}_{s} = L - M )\end{matrix} & ( 2 ) \\ = {Ri}_{s} + {L}_{s} \frac{ⅆ {i}_{s}}{ⅆ t} + \frac{ⅆ θ}{ⅆ t} \cdot \frac{{ϕ}_{r} \cdot ⅆ f ( θ )}{ⅆ θ} & ( 3 ) \\ = {Ri}_{s} + {L}_{s} \frac{ⅆ {i}_{s}}{ⅆ t} + ω \frac{{ϕ}_{r} ⅆ f ( θ )}{ⅆ θ} & ( 4 )\end{matrix}$$

Where, V is the applied voltage to the stator phase winding; iₛ is the energized current in the stator phase winding; R and Lₛ are the register and inductance in the stator phase winding; where, L and M are the self and mutual inductances of the stator winding; λᵣ is the flux linkage due to rotor magnetic field excitation. The

$$\frac{ⅆ {λ}_{r}}{ⅆ t}$$

term, so-called back-EMF, can be divided with speed term and a periodical function changing by rotor position as in equation (3). Here, f(θ) is a new definition that we call flux linkage function and θᵣ is the constant flux value from the rotor. Where, we define H(θ) function as:

$$H ( θ ) = \frac{{ϕ}_{r} ⅆ f ( θ )}{ⅆ θ} \qquad ( 5 )$$

Thus, finally we have:

$$V = {Ri}_{s} + {L}_{s} \frac{ⅆ {i}_{s}}{ⅆ t} + ω \cdot H ( θ ) \qquad ( 6 )$$

The peak magnitude of back-EMF depends on rotor speed ω. However, H(θ) itself has the identical functional waveform by rotor position θ. The defined H(θ) function contains rotor position information, and the shape and peak value of the H(θ) function are speed independent. From equation (6), the H(θ) function can be expressed as:

$$H ( θ ) = \frac{1}{ω} ( V - {Ri}_{s} - {L}_{s} \frac{ⅆ {i}_{s}}{ⅆ t} ) \qquad ( 7 )$$

To eliminate the speed term ω, we divide a phase H(θ) function by another phase H(θ) function. For example,

$$\frac{{H}_{a}}{{H}_{b}} = \frac{\frac{1}{ω} ( {V}_{a} - {Ri}_{a} - {L}_{s} \frac{ⅆ {i}_{a}}{ⅆ t} )}{\frac{1}{ω} ( {V}_{b} - {Ri}_{b} - {L}_{s} \frac{ⅆ {i}_{b}}{ⅆ t} )} = \frac{( {V}_{a} - {Ri}_{a} - {L}_{s} \frac{ⅆ {i}_{a}}{ⅆ t} )}{( {V}_{b} - {Ri}_{b} - {L}_{s} \frac{ⅆ {i}_{b}}{ⅆ t} )} = G ( θ ) \qquad ( 8 )$$

Here, we name this divided function as G(θ).

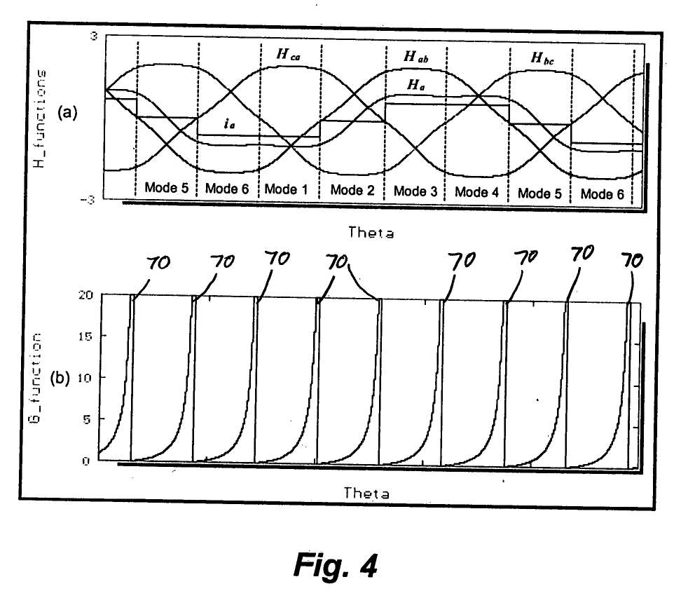

FIG. 4(a) shows waveforms of a phase H(θ) function, line-to-line H(θ) functions, and a square wave current. Here, we utilize two sloped lines of line-to-line H(θ) functions in each mode and divide them to eliminate the speed term ω and to extract sensitive waveforms that are speed independent. The time duration of each mode in FIG. 4(a) corresponds to 60° electrical angles.

TABLE I
G(θ) functions at each mode.

| | |
|---|---|
| Mode 1 and 4 | ${G ( θ )}_{1} = \frac{{H ( θ )}_{bc}}{{H ( θ )}_{ab}} = \frac{{V}_{bc} + {Ri}_{bc} + L \frac{ⅆ {i}_{bc}}{ⅆ t}}{{V}_{ab} - {Ri}_{ab} - L \frac{ⅆ {i}_{ab}}{ⅆ t}}$ |
| Mode 2 and 5 | ${G ( θ )}_{2} = \frac{{H ( θ )}_{ab}}{{H ( θ )}_{ca}} = \frac{{V}_{ab} + {Ri}_{ab} + L \frac{ⅆ {i}_{ab}}{ⅆ t}}{{V}_{ca} - {Ri}_{ca} - L \frac{ⅆ {i}_{ca}}{ⅆ t}}$ |
| Mode 3 and 6 | ${G ( θ )}_{3} = \frac{{H ( θ )}_{ca}}{{H ( θ )}_{bc}} = \frac{{V}_{ca} + {Ri}_{ca} + L \frac{ⅆ {i}_{ca}}{ⅆ t}}{{V}_{bc} - {Ri}_{bc} - L \frac{ⅆ {i}_{bc}}{ⅆ t}}$ |

Table I above shows the equation of the G(θ) functions at each mode. The G(θ) functions, made by combination of two line-to-line H(θ) functions at each mode, can be used for continuous rotor position information as well as commutation points. Because of the division of the equations at each mode, the speed term, ω, is technically eliminated. Since the G(θ) functions are absolutely speed independent, they have an identical shape over all speed ranges. As shown in FIG. 4(a), at mode 1, we calculate H(θ)_{bc/ab} to make G(θ)_{mode1} and after a 60° electrical angle, at mode 2, we shift to H(θ)_{ab/ca} for deriving G(θ)_{mode2}.

Since the waveform of the G(θ) function is identical at the entire speed range, as FIG. 4(b) illustrates, we can characterize the G(θ) function at rated speed with off-line, and use the characterized function as a position reference for sensorless operation at all speeds. Based on Table I, the G(θ) function can be made as FIG. 4(b). It is noted that the commutation signal can be generated at the peak point 70 of the G(θ) function.

When the well-known PWM control scheme is applied, to compute G(θ) function at each mode, each phase voltage vector is derived. The three computed phase voltage vectors Vsf_a, Vsf_b, and Vsf_c are depicted in FIG. 1. To derive these voltage vectors, we can define the switching function of each phase [13]. Each phase has a switching function, such as SF_{—a}, SF_{—b}, and SF_{—c}. Using the switching function SF_{—a,b,c}, the Vₐₒ, V_{bo}, and V_{co} at the peaks 70 shown in FIG. 4 can be obtained as:

$$\begin{matrix}{V}_{ao} = \frac{{V}_{d}}{2} \cdot {SF}_{\_ a} & ( 12 ) \\ {V}_{bo} = \frac{{V}_{d}}{2} \cdot {SF}_{\_ b} & ( 13 ) \\ {V}_{co} = \frac{{V}_{d}}{2} \cdot {SF}_{\_ c} & ( 14 )\end{matrix}$$

where,

SF_{—a}=1 (When Switch S₁ is turned on), SF_{—a}=−1 (When S₄ is turned on)

SF_{—b}=1 (When Switch S₃ is turned on), SF_{—a}=−1 (When S₆ is turned on)

SF_{—c}=1 (When Switch S₅ is turned on), SF_{—a}=−1 (When S₂ is turned on)

Then, the inverter line-to-line voltage vectors (V_{ab}, V_{bc}, V_{ca}) can be derived as:

$$\begin{matrix}{V}_{ab} = {V}_{ao} - {V}_{bo} = \frac{{V}_{d}}{2} ( {SF}_{\_ a} - {SF}_{\_ b} ) \\ {V}_{bc} = {V}_{bo} - {V}_{co} = \frac{{V}_{d}}{2} ( {SF}_{\_ b} - {SF}_{\_ c} ) \\ {V}_{ca} = {V}_{co} - {V}_{ao} = \frac{{V}_{d}}{2} ( {SF}_{\_ c} - {SF}_{\_ a} )\end{matrix} \qquad ( 15 )$$

In normal two-phase current activated operation for the BLDC motor 12, we cannot define the switching function of a silent phase. Therefore, to compute G(θ) functions of each mode, measurement of the terminal voltage of the silent phase is required. But, in accordance with the sensorless systems and methods of the present invention, to avoid putting in additional voltage sensing hardware circuit, we activate three-phase currents (Ia, Ib, Ic) all together and control the silent phase current as zero. By this scheme, we have switching function and can calculate the line-to-line voltage vectors even in silent phase period.

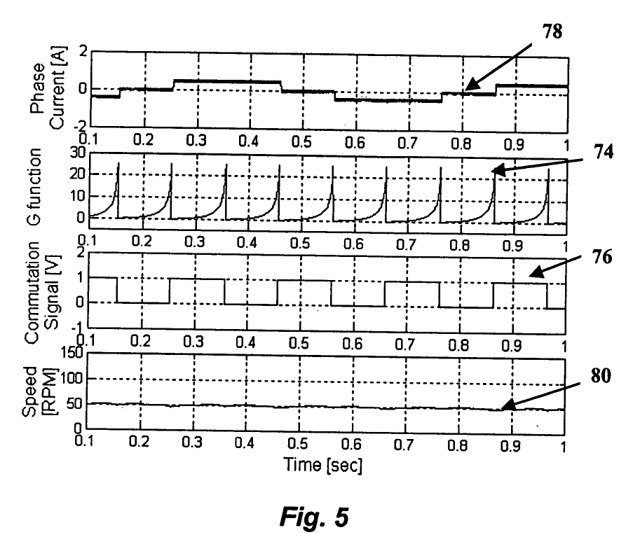

FIG. 5 shows a simulation result of sensorless operation at 50 rpm with the proposed sensorless drive technique. It is noted that the stated G(θ) function 74 is derived by computation even in very low speed operation. Commutation signal 76 is generated at the peak point of the speed independent G(θ) function 74, and phase currents are controlled by a well-known three-phase PWM control scheme. FIG. 5 depicts one such phase current 78, which has been correlated to the commutation signal 76 and G(θ) function 74. Speed 80 of the motor 12 is controlled to remain substantially constant over time.

Table II below shows the specification for an exemplary four-pole BLDC motor 12 system for use with the developed sensorless technique. A BLDC motor 12 drive test-bed is built using PowerRex IGBTs Module as main switches to compose the inverter circuit 14, Fuji EXB-841 as a gate driver 44, TI TMS320F243 (Texas Instrument) microprocessor as a processor 26, and 1 HP permanent magnet DC motor as a constant torque load.

TABLE II
Motor Specification (LL: line-to-line)

| | |
|---|---|
| POWER | 1 HP |
| Rated Speed | 3000 [rpm] |
| R_{—LL} | 7.82 [Ω] |
| L_{—LL} | 77.6 [mH] |
| Kₑ | 1.146 [V/(rad/sec)] |
| Kₜ | 1.605 [Nm/A] |

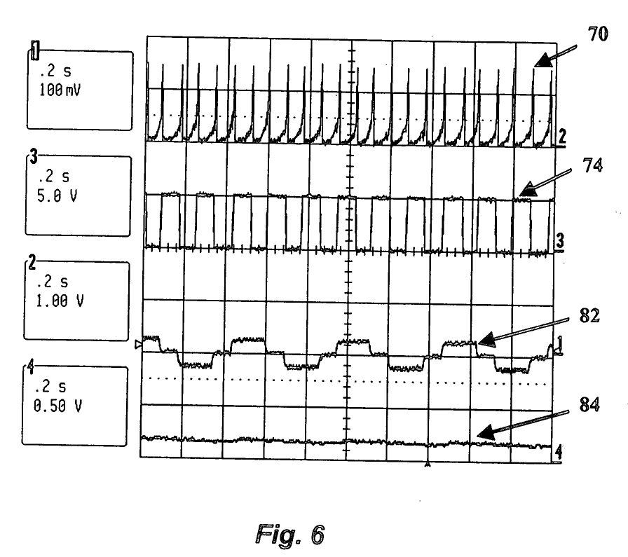

FIG. 6 shows the experimental waveform of the G(θ) function 70 and currents 82, 84 at 50 rpm with three-phase current control scheme using a TMS320F243 as the processor 26. This experiment was done to observe the computed G(θ) function waveform at low speed. The computed G(θ) function is written to a D/A converter port to observe using an oscilloscope. At the peak-point 70 of the G(θ) function 74, we do commutation to continually synchronize the phase excitation with the flat part of the back-EMF. Based on our experiment, we conclude that sensorless operation down to 10 rpm or lower is possible. The minimum speed depends on measurement error of currents and temperature effect of winding resistance R. Since PM motors have large air-gaps, saturation effects caused by current level may be ignored. From FIGS. 5 and 6, the validity of the developed sensorless drive technique for BLDCM using the new speed-independent function is successfully verified.

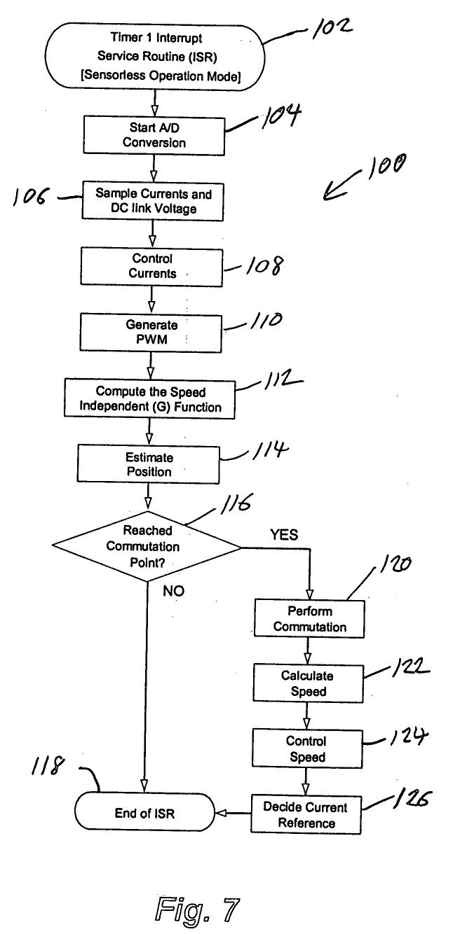

FIG. 7 is a flow diagram illustrating steps in an exemplary method 100 for motor control performed in accordance with the present invention. In the method 100, the motor drive system 10 is provided with a timer (see block 102) which is typically on-board the processor 26 to control operation of iterative steps in the method and to control starting and stopping of the process. According to the exemplary method 100, the timer begins an interrupt service routine (ISR) is step 102. The rectifier 22 of the drive system 10 then begins analog-to-digital conversion of the power supply 24 (step 104). In step 106, the phase currents Ia, Ib and DC reference voltage Vdc are detected from leads 16, 18, as described previously. In step 108, the gate pulse/current control 44 of the processor 26 controls the currents of the inverter 14 using the input of the commutation signal 42. In step 110, the processor 26 generates a PWM modulation control scheme, and in step 112, the processor 26 computes the G(θ) function for the motor 12, and, each phase voltage vector Vsf_a, Vsf_b, Vsf_c is derived. Next (step 114), rotor position is estimated by the position estimation means 38.

After rotor position has been estimated, the drive system 10 then determines whether the commutation point has been reached (see block 116). If not, the ISR ends (block 118). If so, however, the system 10 performs commutation (step 120), calculates speed of the motor 12 (step 122), controls the speed (step 124), and determines reference currents Ia-ref, Ib-ref, and Ic-ref (step 126). The process 100 then ends.

Although the systems and methods of the present invention have been described above with respect to a three-phase brushless DC motor, those of skill in the art will understand that it is applicable as well to motors having other number of phases (i.e., two, four, five, etc.). In such a case, the number of motor phase currents (Ia, Ib . . . ) that are measured by the drive system will number one less than the total number of motor phases. For a five-phase motor, for example, four phase currents would be measured.

Those of skill in the art will recognize that many modifications and changes may be made

What is claimed is:

1. A brushless DC motor drive system comprising:
a multiphase, brushless DC motor;
a voltage signal inverter;
a plurality of motor leads extending between the motor and the inverter, the number of motor leads corresponding to the number of phases for the motor;
means for detecting current from at least some of said motor leads and generating signals indicative of said current; and
position estimation means for receiving signals indicative of current within the motor leads and of a reference voltage and determining motor rotor position from said signals.

2. The motor drive system of claim 1 further comprising a speed calculation means for receiving signals indicative of current within the motor leads and of a reference voltage and determining speed of the motor therefrom.

3. The motor drive system of claim 1 further comprising a gate pulse for controlling current within the inverter.

4. The motor drive of claim 2 further comprising a comparator for:
a) receiving a calculated speed signal from the speed calculation means;
b) comparing the calculated speed signal to a reference speed; and
c) generating a differential signal for correction of calculated speed.

5. The motor drive of claim 4 further comprising a means for controlling speed of the motor.

6. The motor drive of claim 1 wherein there are “n” number of motor leads, and the means for detecting current detects current from “n−1” number of motor leads.

7. The motor drive of claim 1 wherein the position estimation means does not receive detected line terminal voltage as an input.

8. The motor drive of claim 1 wherein the position estimation means does not receive back-EMF as an input.

9. The motor drive of claim 1 wherein the position estimation means does not utilize motor speed as a factor in determining rotor position.

10. A method of determining rotor position for a brushless DC motor comprising the steps of:
measuring current (Ia, Ib, . . . ) from “n−1” number of motor leads, wherein there are “n” motor leads;
measuring a reference voltage Vdc;
determining rotor position for the DC motor from the measured current and reference voltage Vdc without considering back-EMF or terminal voltage.

11. The method of claim 10 further comprising the steps of determining motor speed and controlling motor speed.

12. The method of claim 10 wherein rotor position is determined without regard to the motor speed.

13. The method of claim 11 wherein motor speed is controlled by:
a) comparing determined motor speed to a reference speed to result in a motor speed differential; and
b) correcting the motor speed differential.

14. The method of claim 10 further comprising the step of controlling currents in the inverter by gate pulses based upon a generated commutation signal.

15. The method of claim 10 wherein the step of determining rotor position further comprises:
comparing the measured currents (Ia, Ib, . . . ) to predetermined reference currents (Ia-ref, Ib-ref, . . . );
determining rotor position information H(θ) function; and
determining a further speed-independent G(θ) function which peaks to indicate rotor switching positions.
